(19) United States
(12) Patent Application Publication
(10) Pub. No.: US 2019/0111731 A1
(43) Pub. Date: Apr. 18, 2019

(54) VEHICLE WHEEL

(71) Applicant: HONDA MOTOR CO., LTD., Tokyo (JP)

(72) Inventor: Youichi KAMIYAMA, Wako-shi, Saitama (JP)

(21) Appl. No.: 16/084,455

(22) PCT Filed: Mar. 16, 2017
(86) PCT No.: PCT/JP2017/010798

§ 371 Date: Sep. 12, 2018

(30) Foreign Application Priority Data
Mar. 16, 2016 (JP) 2016-052011

(51) Int. Cl. B60B 21/02; B60B 21/12

(52) U.S. Cl. CPC B60B 21/02; B60B 2900/133; B60B 21/12

(57) ABSTRACT

An auxiliary air chamber member includes connecting portions recessed into an auxiliary air chamber from an upper surface portion and a lower surface portion to partially connect the upper surface portion and the lower surface portion. A non-connecting portion of the lower surface portion excluding the connecting portions is a curved surface corresponding to a shape of an outer peripheral surface of a well portion. The connecting portions are arranged separated equally in a wheel circumferential direction and include a first connecting portion on one side and a second connecting portion on the other side arranged in parallel in a wheel width direction. One of the connecting portions is disposed at a position in an offset plus direction and the other is disposed at a position in an offset minus direction with reference to a cross-sectional center of gravity in the wheel width direction.

### TECHNICAL FIELD

The present invention relates to a vehicle wheel.

### BACKGROUND ART

Conventionally, as a wheel for reducing road noise caused by air column resonance in a tire air chamber, the wheel provided with a Helmholtz resonator (an auxiliary air chamber member) having an auxiliary air chamber communicating with the tire air chamber through a communication hole has been variously proposed.

The auxiliary air chamber member includes a main body portion having the auxiliary air chamber therein and formed long in a wheel circumferential direction (for example, see Patent Document 1). A plurality of beads, which extend in a wheel width direction and are arranged side by side in the wheel circumferential direction, are formed on the inner side in a wheel radial direction of the main body portion. A plurality of upper connecting portions recessed toward the lower surface side is formed on the upper surface side of the main body portion. A plurality of lower connecting portions arranged at positions corresponding to the upper connecting portions and recessed upward is formed on the lower surface side of the main body portion. The upper connecting portions and the lower connecting portions corresponding to each other are joined to each other at bottom portions thereof. The plurality of upper connecting portions and the lower connecting portions are respectively located on the beads and are arranged in two rows in the wheel circumferential direction.

### CITATION LIST

### Patent Literature

Patent Document 1: Japanese Patent Application Publication No. 2015-174495

### SUMMARY OF INVENTION

### Technical Problem

Incidentally, in order to improve sound deadening property for road noise, it is preferable to increase a volume of the auxiliary air chamber of the auxiliary air chamber member as much as possible. It is because when a volume of the auxiliary air chamber is reduced, a sound deadening effect is reduced with respect to an air column resonance sound in the tire air chamber in the auxiliary air chamber member, and thus the road noise caused by the air column resonance sound in the tire air chamber cannot be sufficiently reduced.

In order to increase the volume of the auxiliary air chamber, for example, it is considered to extend a circumferential length of the auxiliary air chamber member. However, when the length in the circumferential direction of the auxiliary air chamber member is extended longer than in the related art, an unsprung weight increases and another trouble occurs that an assembling performance of the auxiliary air chamber member to the wheel deteriorates.

A general object of the present invention is to provide a vehicle wheel capable of increasing the volume of an auxiliary air chamber of an auxiliary air chamber member as compared with the related art while suppressing deformation by a centrifugal force to a desired amount.

### Solution to Problem

In order to achieve the above object, a vehicle wheel according to the present invention is a vehicle wheel with an auxiliary air chamber member as a Helmholtz resonator mounted on an outer peripheral surface of a well portion, wherein the auxiliary air chamber member includes: a lower surface portion disposed on the outer peripheral surface side of the well portion; an upper surface portion disposed radially outward of the lower surface portion; an auxiliary air chamber formed between the upper surface portion and the lower surface portion; a first edge portion and a second edge portion respectively connecting the lower surface portion and the upper surface portion on both sides in a width direction and engaged with the well portion; and a plurality of connecting portions recessed into the auxiliary air chamber from at least one of the upper surface portion and the lower surface portion to partially connect the upper surface portion and the lower surface portion, and wherein a non-connecting portion of the lower surface portion excluding the plurality of connecting portions is a curved surface corresponding to a shape of the outer peripheral surface of the well portion, the plurality of connecting portions are arranged separated at equal intervals in a wheel circumferential direction and have a first connecting portion on one side and a second connecting portion on the other side which are arranged in parallel in a wheel width direction, and the first connecting portion and the second connecting portion are respectively arranged offset in the wheel width direction with reference to a cross-sectional center of gravity G.

According to the present invention, the non-connecting portion of the lower surface portion excluding the plurality of connecting portions is the curved surface corresponding to the shape of the outer peripheral surface of the well portion, and thus it is the curved surface in which the so-called bead is not formed on the lower surface portion. Thus, according to the present invention, the volume of the auxiliary air chamber member can be increased by a volume of the bead which has been conventionally provided.

Further, in the present invention, the first connecting portion and the second connecting portion are respectively arranged offset in the wheel width direction with reference to the cross-sectional center of gravity G (offset in a plus direction and a minus direction with reference to the cross-sectional center of gravity G), and thus it is possible to arrange them at positions spaced apart as much as possible from the cross-sectional center of gravity G on which the maximum centrifugal force is considered to act. Thus, according to the present invention, it is possible to arrange them at a balance point which is compatible with an amount of deformation when an internal pressure is applied while suppressing the amount of deformation when the centrifugal force is applied. As a result, according to the present invention, even when the conventional bead is not provided on the lower surface portion, the volume of the auxiliary air chamber of the auxiliary air chamber member can be increased compared to the related art while suppressing the deformation by the centrifugal force to the desired amount.

Further, in the present invention, a separation distance from the cross-sectional center of gravity G to the first connecting portion disposed offset in the wheel width direction and a separation distance from the cross-sectional center of gravity G to the second connecting portion disposed offset in the wheel width direction are different from each other.

According to the present invention, since the separation distances in the wheel width direction with reference to the cross-sectional center of gravity G are different from each other, the first connecting portion and the second connecting portion can be effectively arranged by distributing them in a well-balanced manner.

Further, in the present invention, the auxiliary air chamber member does not include a bead connecting the first connecting portion and the second connecting portion.

According to the present invention, since the auxiliary air chamber member does not have the bead connecting the first connecting portion and the second connecting portion, the volume of the auxiliary air chamber member can be increased by the volume of the bead which has been conventionally provided. In that case, even when the bead is not provided, the first connecting portion and the second connecting portion are respectively arranged offset in the wheel width direction with reference to the cross-sectional center of gravity and thus it is possible to arrange them at the positions spaced apart as much as possible from the cross-sectional center of gravity G on which the maximum centrifugal force is considered to act. Thus, according to the present invention, it is possible to arrange them at the balance point which is compatible with the amount of deformation when the internal pressure is applied while suppressing the amount of deformation when the centrifugal force is applied.

### Advantageous Effects of Invention

According to the present invention, it is possible to obtain a vehicle wheel capable of increasing the volume of the auxiliary air chamber of the auxiliary air chamber member as compared with the related art while suppressing the deformation by the centrifugal force to the desired amount.

### BRIEF DESCRIPTION OF DRAWINGS

FIG. 1 is a perspective view of a vehicle wheel according to an embodiment of the present invention;

FIG. 2 is a partially enlarged vertical cross-sectional view taken along a line II-II in FIG. 1;

FIG. 3 is a partially enlarged vertical cross-sectional view taken along a line in FIG. 1;

FIG. 4 is a perspective view of an auxiliary air chamber member;

FIG. 5A is a plan view of the auxiliary air chamber member shown in FIG. 4 as viewed from an outer side in a wheel radial direction;

FIG. 5B is a bottom view of the auxiliary air chamber member shown in FIG. 4 as viewed from an inner side in the wheel radial direction;

FIG. 6 is a schematic cross-sectional view showing an arrangement structure of a connecting portion of the present embodiment;

FIG. 7A is a schematic cross-sectional view showing the arrangement structure of the connecting portion of Comparative Example 1 devised by the present applicant; and

FIG. 7B is a schematic cross-sectional view showing the arrangement structure of the connecting portion of Comparative Example 2 devised by the present applicant.

### DESCRIPTION OF EMBODIMENTS

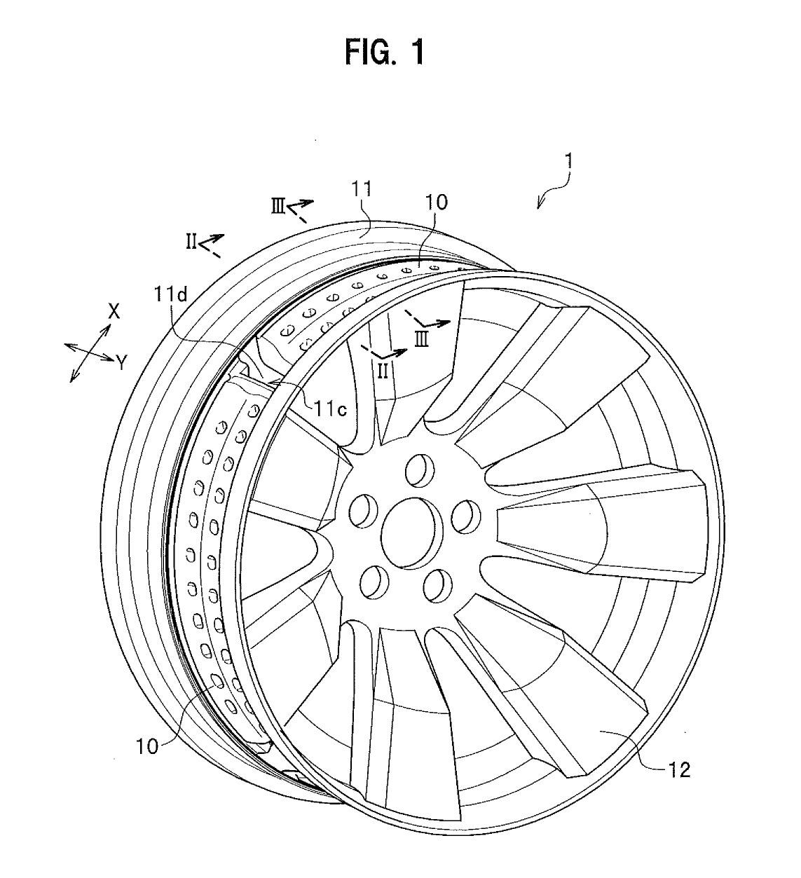

Next, an embodiment of the present invention will be described in detail with reference to the drawings as appropriate. FIG. 1 is a perspective view of a vehicle wheel according to an embodiment of the present invention. In the drawings, “X” indicates a wheel circumferential direction, “Y” indicates a wheel width direction, and “Z” indicates a wheel radial direction. Further, in the wheel width direction Y, an inner side is indicated as “one side”, and an outer side is indicated as “the other side”.

As shown in FIG. 1, a vehicle wheel 1 according to the present embodiment has a plurality of auxiliary air chamber members 10 as Helmholtz resonators at equal intervals in the wheel circumferential direction X. Incidentally, in the present embodiment, it is assumed that four auxiliary air chamber members 10 are arranged in the wheel circumferential direction X of the vehicle wheel 1.

The vehicle wheel 1 includes a rim 11 and a disk 12 for connecting the rim 11 to a hub (not shown). An auxiliary air chamber member 10 is fitted into and mounted on an outer peripheral surface 11d of a well portion 11c of the rim 11.

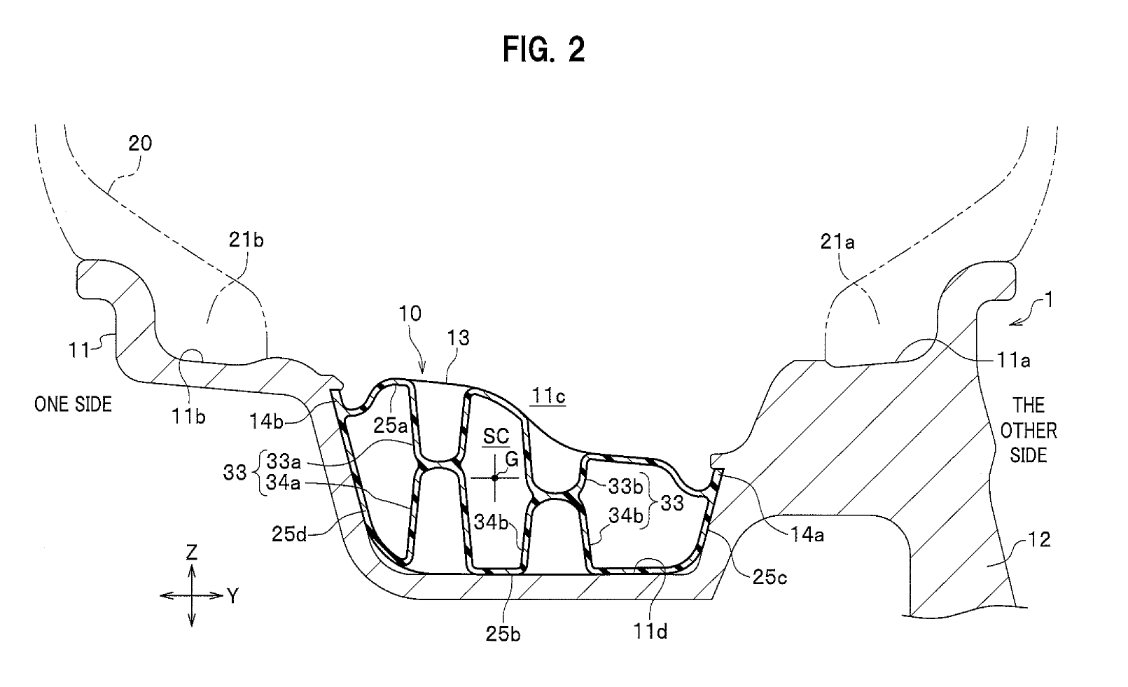

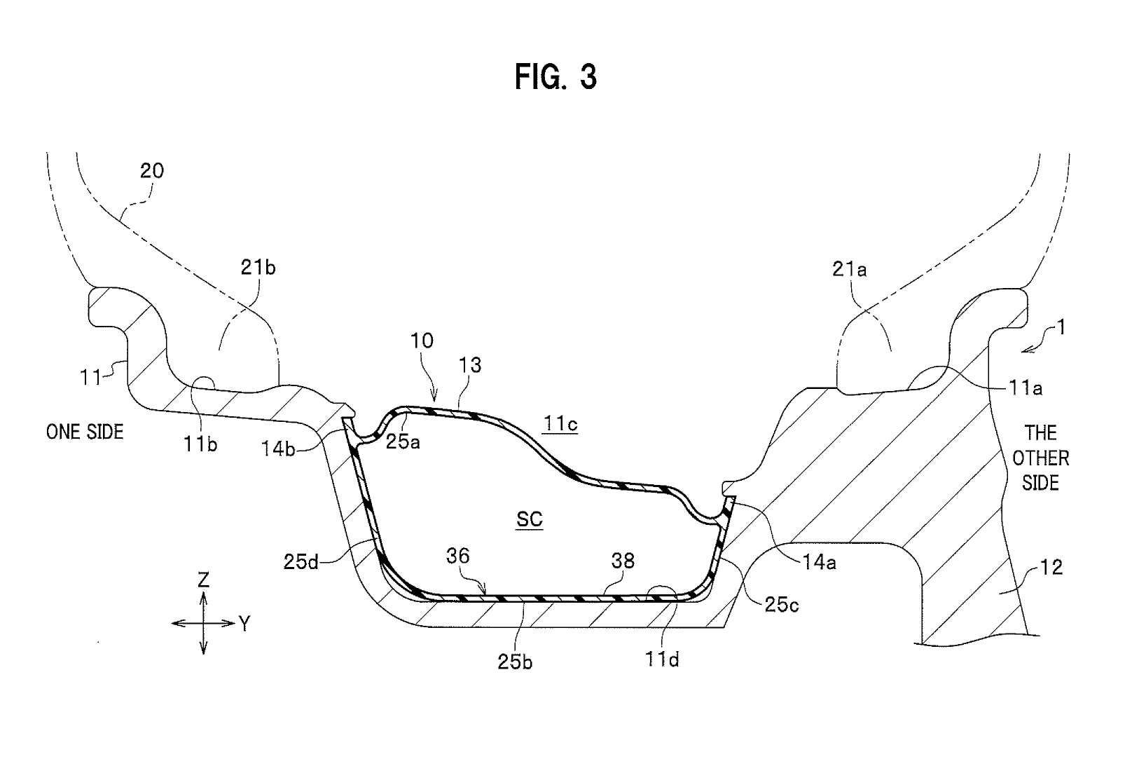

FIG. 2 is a partially enlarged vertical cross-sectional view taken along a line II-II in FIG. 1, and FIG. 3 is a partially enlarged vertical cross-sectional view taken along a line in FIG. 1. As shown in FIG. 2, the rim 11 has the well portion 11c recessed to the inner side (rotation center side) in the wheel radial direction Z between bead seats 11a and 11b formed at both end portions in the wheel width direction Y.

The well portion 11c is provided for fitting bead portions 21a, 21b of a tire 20 thereto when the tire 20 is assembled to the rim 11. Incidentally, the well portion 11c of the present embodiment is formed into a cylindrical shape having substantially the same diameter over the wheel width direction Y.

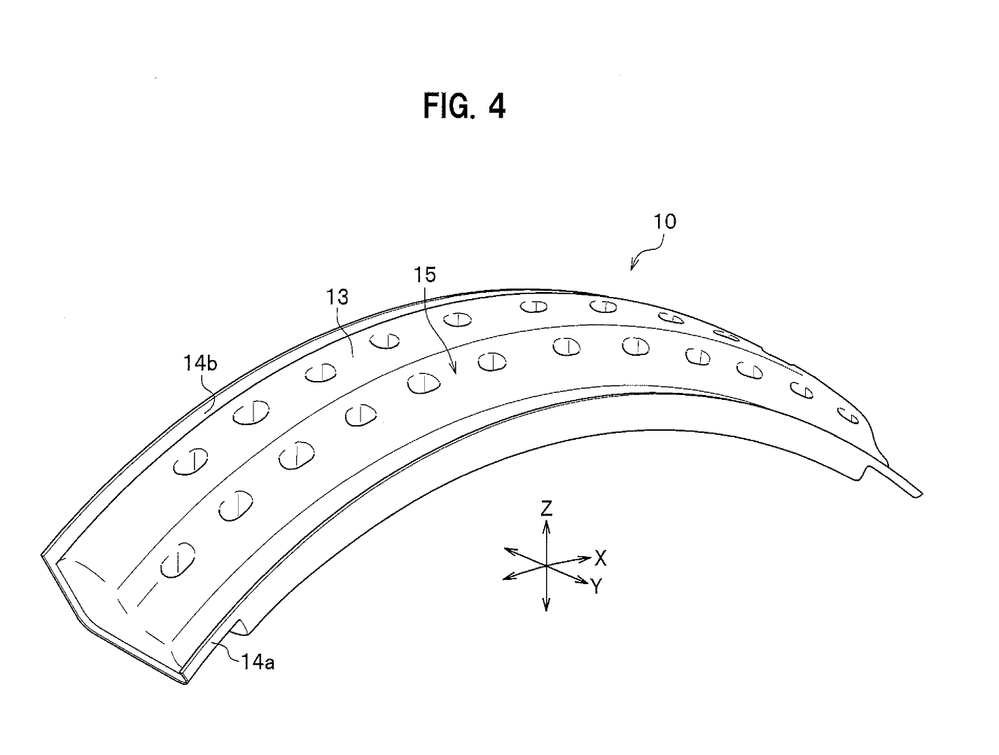

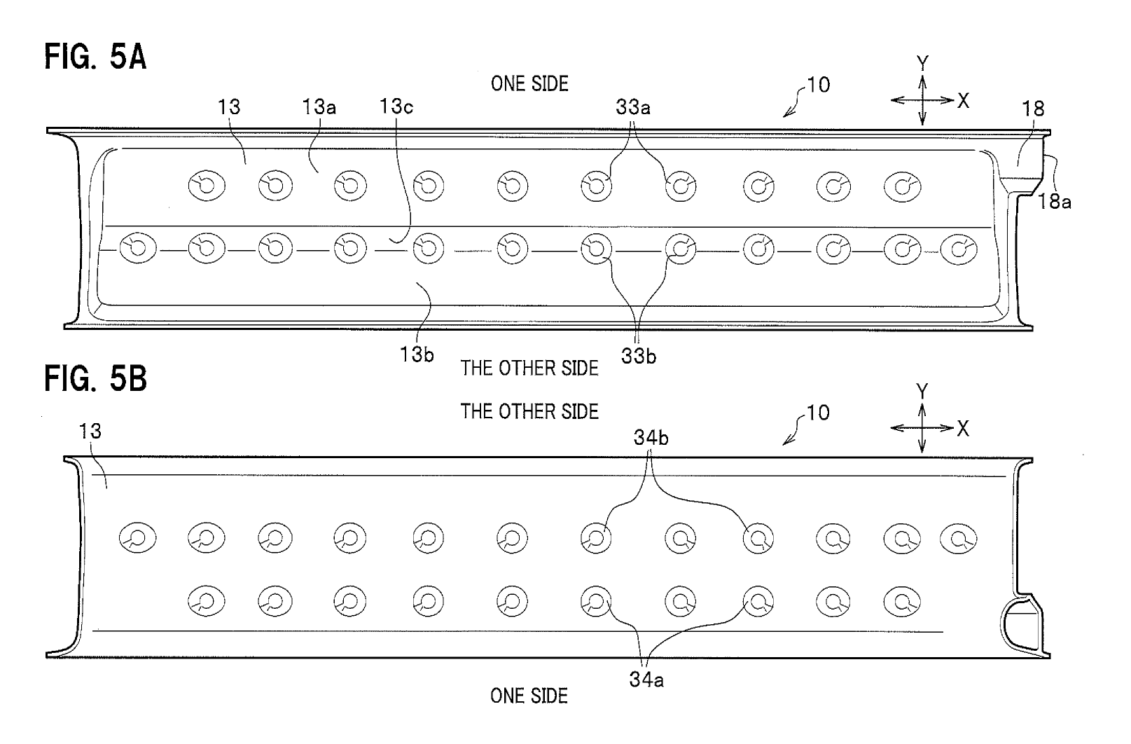

FIG. 4 is a perspective view of an auxiliary air chamber member, FIG. 5A is a plan view of the auxiliary air chamber member shown in FIG. 4 as viewed from the outer side in the wheel radial direction, and FIG. 5B is a bottom view of the auxiliary air chamber member shown in FIG. 4 as viewed from the inner side in the wheel radial direction.

As shown in FIG. 4, the auxiliary air chamber member 10 is a long member in a direction and includes a hollow main body portion 13 having an auxiliary air chamber SC (see FIG. 2) to be described below therein, and a pair of edge portions 14a and 14b. The pair of edge portions 14a and 14b is for engaging the auxiliary air chamber member 10 to the well portion 11c.

The auxiliary air chamber member 10 is curved in its longitudinal direction and is configured to follow the wheel circumferential direction X when attached to the outer peripheral surface 11d of the well portion 11c (see FIG. 1). The main body portion 13 has a pipe body 18 at an end portion in the longitudinal direction (wheel circumferential direction X), and a communication hole 18a communicating with the auxiliary air chamber SC is formed inside the pipe body 18 (see FIG. 5A).

As shown in FIG. 5A, the auxiliary air chamber member 10 has a long rectangular body in a plan view. As shown in FIGS. 2 and 3, the main body portion 13 of the auxiliary air chamber member 10 includes a lower surface portion 25b which is a bottom plate disposed along the outer peripheral surface 11d side (see FIG. 1) of the well portion 11c, an upper surface portion 25a which is an upper plate arranged radially outwardly of the lower surface portion 25b and opposed to the lower surface portion 25b, and the auxiliary air chamber SC formed between the upper surface portion 25a and the lower surface portion 25b. In the present embodiment, the resin materials constituting the upper surface portion 25a and the lower surface portion 25b have the same thickness, but these thicknesses may be different from each other.

As shown in FIG. 2, a first side wall 25c which is a vertical wall is formed inner side in the wheel width direction Y between the upper surface portion 25a and the lower surface portion 25b. Further, a second side wall 25d which is a vertical wall is formed outer side in the wheel width direction Y. The first side wall 25c and the second side wall 25d are arranged to face each other in the wheel width direction Y.

Further, the main body portion 13 of the auxiliary air chamber member 10 includes a first edge portion 14a and a second edge portion 14b which respectively connect the lower surface portion 25b and the upper surface portion 25a at both sides in the width direction and are engaged with the well portion 11c, and a plurality of connecting portions 33 which partially connect the upper surface portion 25a and the lower surface portion 25b by being respectively recessed into the auxiliary air chamber SC from the upper surface portion 25a and the lower surface portion 25b.

The upper surface portion 25a is located above the lower surface portion 25b disposed along the outer peripheral surface 11d side of the well portion 11c and is curved to bulge to form the auxiliary air chamber SC. Incidentally, the communication hole 18a (see FIG. 5A) of the pipe body 18 disposed at the end portion in the wheel peripheral direction X of the main body portion 13 communicates with the auxiliary air chamber SC at one end side in the wheel circumferential direction X, and opens to the outside at the other end side.

A length of the auxiliary air chamber member 10 in the wheel circumferential direction X may be appropriately set in consideration of adjustment of a weight of the vehicle wheel 1 and an assembling property to the well portion 11c, with a half length of a circumferential length (circumferential length of the outer peripheral surface 11d of the well portion 11c) of the rim 11 (see FIG. 1) as a maximum.

As shown in FIG. 2, a pair of upper connecting portions 33a, 33b is formed in the wheel width direction in a portion constituting the main body portion 13 on the upper surface portion 25a. The pair of upper connecting portions 33a, 33b is composed of the upper connecting portion 33a on one side (inner side) in the wheel width direction Y and the upper connecting portion 33b on the other side (outer side) in the wheel width direction Y. The pair of upper connecting portions 33a, 33b is formed so that the upper surface portion 25a is recessed toward the lower surface portion 25b and is formed in a circular shape in a plan view. The pair of upper connecting portions 33a, 33b is juxtaposed in two rows in a width direction of the main body portion 13 along the longitudinal direction (wheel circumferential direction X) of the auxiliary air chamber member 10.

A pair of lower connecting portions 34a, 34b is formed on the lower surface portion 25b at positions corresponding to the pair of upper connecting portions 33a, 33b. Both the upper connecting portions 33a, 33b and the lower connecting portions 34a, 34b are combined to form the connecting portions 33. The lower connecting portions 34a, 34b are formed so that the lower surface portion 25b is recessed toward the upper surface portion 25a, and are formed in a circular shape as viewed from the bottom. The lower connecting portions 34a, 34b have their distal end portions integrated with distal end portions of the upper connecting portions 33a, 33b of the upper surface portion 25a, to partially connect the upper surface portion 25a and the lower surface portion 25b.

In other words, the upper surface portion 25a and the lower surface portion 25b are integrally and partially connected via the upper connecting portions 33a, 33b and the lower connecting portions 34a, 34b which are connected to each other at their bottoms.

The upper connecting portion 33a and the lower connecting portion 34a arranged on the inner side (one side) in the wheel width direction Y are higher in the wheel radial direction Z than that of the upper connecting portion 33b and the lower connecting portion 34b arranged on the outer side (the other side) in the wheel width direction Y (see FIG. 2).

Incidentally, the upper connecting portions 33a, 33b and the lower connecting portions 34a, 34b connected to each other in the auxiliary air chamber SC improve a mechanical strength of the auxiliary air chamber member 10 and prevent variation of a volume of the auxiliary air chamber SC, to exert a sound deadening function.

In the present embodiment, as shown in FIG. 5B, anything that connects the lower connecting portion 34a on the inner side in the wheel width direction Y and the lower connecting portion 34b on the outer side in the wheel width direction Y is not formed on the lower surface portion 25b. That is, in the related art disclosed in Patent Document 1, a bead B (so-called lateral bead) in which the lower surface portion 25b is partially recessed toward the upper surface portion 25a and extends in the wheel width direction Y is formed. The bead B connects the lower connecting portion 33b on the one side and the lower connecting portion 34b on the other side, so that a surface rigidity of the lower surface portion 25b is increased.

In contrast, in the present embodiment, no one corresponding to the bead B disclosed in Patent Document 1 is formed on the lower surface portion 25b. In the present embodiment, the lower connecting portion 34a disposed on the one side (inner side) in the wheel width direction Y and the lower connecting portion 34b disposed on the other side (outer side) in the wheel width direction Y are not connected to each other but separated from each other by a predetermined distance. As shown in FIG. 3, a non-connecting portion 36 of the lower surface portion 25b excluding the plurality of connecting portions 33 is formed by a curved surface 38 corresponding to a shape of the outer peripheral surface 11d of the well portion 11c.

A cross-sectional center of gravity G for balancing the auxiliary air chamber member 10 in the wheel circumferential direction X, in the wheel width direction Y, and in the wheel radial direction Z is provided in a cross-section of the main body portion 13 in the wheel width direction Y. The cross-sectional center of gravity G is appropriately set depending on a shape, weight, or the like of the auxiliary air chamber member 10.

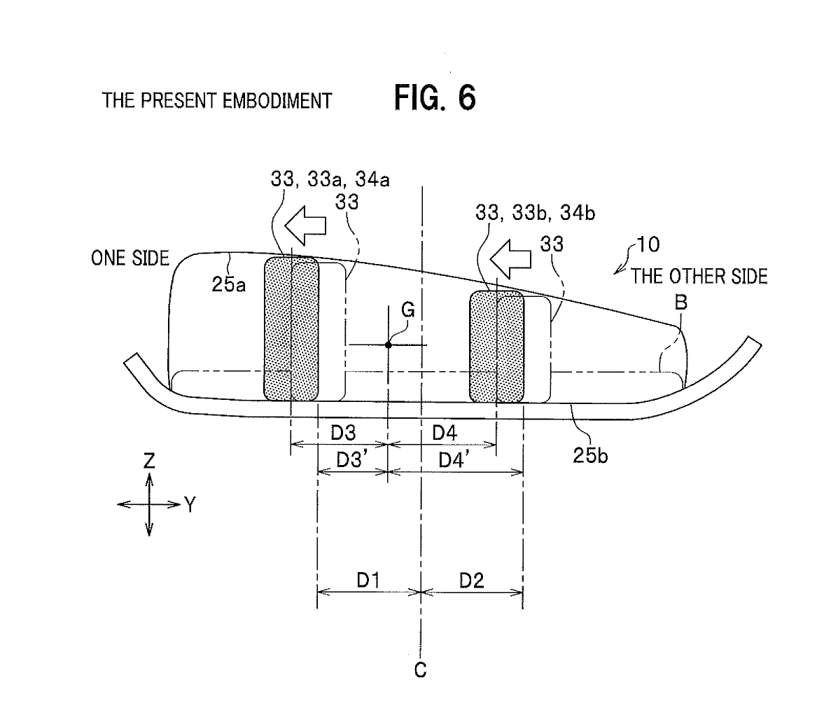

FIG. 6 is a schematic cross-sectional view showing an arrangement structure of a connecting portion of the present embodiment. In FIG. 6, a halftone dot portion on the one side schematically shows the connecting portion 33 on the one side where the upper connecting portion 33a and the lower connecting portion 34a are combined, and a halftone dot portion on the other side schematically shows the connecting portion 33 on the other side where the upper connecting portion 33b and the lower connecting portion 34b are combined. Further, two-dot chain lines show the connecting portions 33 on the one side and the other side, which are separated by an equal distance from a center axis C. The connecting portion 33 (the upper connecting portion 33a and the lower connecting portion 34a) on the one side (inner side) in the wheel width direction Y of the auxiliary air chamber member 10 and the connecting portion 33 (the upper connecting portion 33b and the lower connecting portion 34b) on the other side (outer side) are respectively arranged at predetermined positions in the wheel width direction Y with reference to the cross-sectional center of gravity G. This point will be described in detail below.

The vehicle wheel 1 according to the present embodiment is basically configured as described above, and its function and effect will be described next.

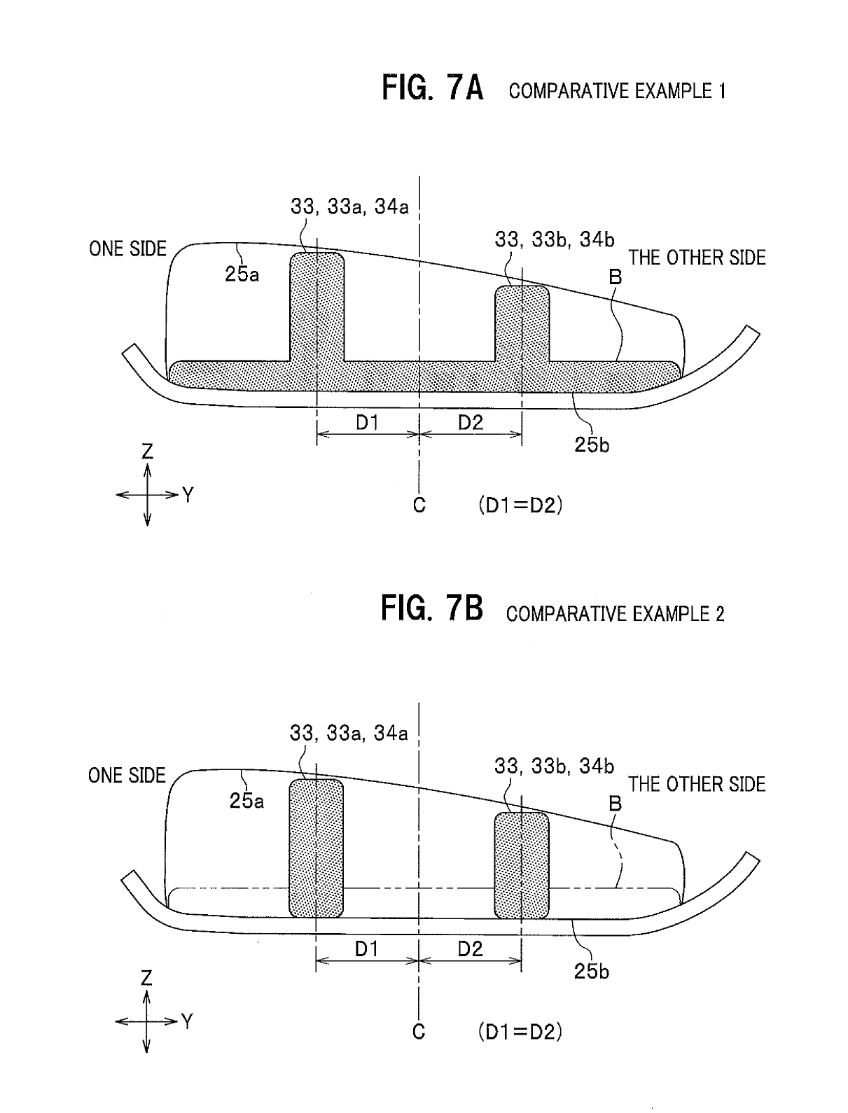

FIG. 7A is a schematic cross-sectional view showing the arrangement structure of the connecting portion of Comparative Example 1 devised by the present applicant, and FIG. 7B is a schematic cross-sectional view showing the arrangement structure of the connecting portion of Comparative Example 2 devised by the present applicant. In Comparative Example 1 and Comparative Example 2, the same reference numerals are denoted to components corresponding to constituent elements of the present embodiment.

As shown in FIG. 7A, Comparative Example 1 is provided with the beads B for respectively connecting the lower connecting portion 33b on the one side (inner side) and the lower connecting portion 34b on the other side (outer side). In Comparative Example 1, the connecting portion 33 on the one side and the connecting portion 33 on the other side are arranged separated by an equal distance (D1=D2) with reference to the center axis C in the wheel width direction Y of the auxiliary air chamber member 10.

As shown in FIG. 7B, Comparative Example 2 is similar to Comparative Example 1 in that the connecting portion 33 on the one side and the connecting portion 33 on the other side are arranged separated by the equal distance (D1=D2) with reference to the center axis C in the wheel width direction Y of the auxiliary air chamber member 10, but is different from Comparative Example 1 in that no bead B is provided. In other words, in Comparative Example 2, only the bead B is simply removed from the structure of Comparative Example 1, and the other structures are similar to those of Comparative Example 1.

Comparative Example 1 has the same structure as that of the related art disclosed in Patent Document 1, and the bead B (so-called lateral bead) is formed in which the lower surface portion 25b is partially recessed toward the upper surface portion 25a and extends in the wheel width direction Y. Since the beads B respectively connects the lower connecting portion 33b on the one side and the lower connecting portion 34b on the other side, the surface rigidity of the lower surface portion 25b is increased. However, in the structure of Comparative Example 1, a volume of the auxiliary air chamber SC decreases by a volume of the bead B.

In Comparative Example 2, since the bead B connecting the inner connecting portion 33 and the outer connecting portion 33 is not provided, it is possible to increase the volume of the auxiliary air chamber SC by the volume of the bead B. However, in Comparative Example 2, compared with Comparative Example 1, for example, there is a possibility that a cross-sectional bending rigidity of the auxiliary air chamber member 10 is reduced to increase an amount of internal pressure deformation, and an amount of centrifugal force deformation caused by centrifugal force due to a balance change of mass is increased.

In contrast, in the present embodiment, as shown in FIG. 3, the non-connecting portion 36 of the lower surface portion 25b excluding the plurality of connecting portions 33 is the curved surface 38 corresponding to the shape of the outer peripheral surface 11d of the well portion 11c, and thus it is the curved surface 38 in which the so-called bead B is not formed on the lower surface portion 25b. Thus, in the present embodiment, as shown in FIG. 6, the volume of the auxiliary air chamber member 10 can be increased by the volume of the bead B (see the two-dot chain line) conventionally provided.

Further, in the present embodiment, as shown in FIG. 6, the connecting portion 33 (the upper connecting portion 33a and the lower connecting portion 33b) on the one side (inner side) in the wheel width direction Y of the sub air chamber member 10 and the connecting portion 33 (the upper connecting portion 33b and the lower connecting portion 34b) on the other side (outer side) are respectively arranged offset in a plus direction and a minus direction with reference to the cross-sectional center of gravity G. The “cross-sectional center of gravity” is a position in which cross-sectional areas in the left and right (the cross-sectional area in the one side and the cross-sectional area in the other side) in the cross-sectional view are equal.

That is, in the present embodiment, the connecting portion 33 on the one side (inner side) in the wheel width direction Y of the auxiliary air chamber member 10 is disposed at a position (position away from the cross-sectional center of gravity G) plus-offset in a direction away from the cross-sectional center of gravity G with respect to the connecting portion 33 (see the two-dot chain line in FIG. 6) of Comparative Examples 1 and 2. Further, in the present embodiment, the connecting portion 33 on the other side (outer side) is disposed at a position minus-offset in a direction approaching the cross-sectional center of gravity G with respect to the connecting portion 33 (see the two-dot chain line in FIG. 6) of Comparative Examples 1 and 2.

As for a plus and minus of an amount of offset, it is a plus offset (D3>D3′) when a separation distance from the cross-sectional center of gravity G is long with reference to the connecting portion 33 (see the two-dot chain line) of Comparative Example disposed at the equal distance (D1=D2) from the center axis C, and it is a minus offset (D4<D4′) when the separation distance from the cross-sectional center of gravity G is short. The amount of offset of each connecting portion 33 does not need to be equal between the plus direction and the minus direction, and may be unequal, for example, as a left-right asymmetric cross-sectional shape (D3 D4).

In the present embodiment, two rows of connecting portions 33 on the one side (inner side) and the other side (outer side) are distributed in the plus direction (plus offset; D3>D3′) and in the minus direction (minus offset; D4<D4′) in the wheel width direction Y with reference to the cross-sectional center of gravity G of a point on which the centrifugal force acts, within an allowable range (within a reference) of an amount of surface deformation when an internal pressure is applied, and thus an optimum balance arrangement can be achieved. Specifically, in the present embodiment, it is possible to prevent reduction in the cross-sectional bending rigidity of the auxiliary air chamber member 10 to prevent the amount of internal pressure deformation, and to prevent increase in the amount of centrifugal force deformation caused by the centrifugal force due to the balance change of mass. As a result, in the present embodiment, even when the conventional bead B is not provided, it is possible to increase the volume of the auxiliary air chamber SC of the auxiliary air chamber member 10 as compared with the related art while suppressing the deformation by the centrifugal force to the desired amount.

As described above, in the present embodiment, by suppressing reduction in cross-sectional rigidity when the bead is not provided and by optimizing a balance of mass arrangement of the connecting portion 33, it is possible to suppress the amount of centrifugal force deformation and the amount of internal pressure deformation within a reference when the internal pressure is applied, thereby balancing both of them.

In the present embodiment, it is arranged so that the separation distance (D3) from the cross-sectional center of gravity G to the connecting portion 33 on the one side and the separation distance (D4) from the cross-sectional center of gravity G to the connecting portion 33 on the other side are different from each other (D3<D4) in the wheel width direction Y of the auxiliary air chamber member 10 (see FIG. 6). In the present embodiment, since the separation distances in the wheel width direction Y are different from each other with reference to the cross-sectional center of gravity it is possible to effectively arrange the connecting portion 33 on the one side and the connecting portion 33 on the other side by distributing them in a well-balanced manner.

In the present embodiment, the separation distances in the wheel width direction Y of the auxiliary air chamber member 10 are different from each other, however, the present invention is not limited thereto, but the separation distance (D3) from the cross-sectional center of gravity G to the connecting portion 33 on the one side and the separation distance (D4) from the cross-sectional center of gravity G to the connecting portion 33 on the other side may be the same (D3=D4).

In the present embodiment, it is possible to further improve sound deadening property for road noise by increasing the volume of the auxiliary air chamber member 10 by the volume of the bead B (see the two-dot chain line). Further, in the present embodiment, a length in the circumferential direction of the auxiliary air chamber member 10 is reduced by an amount corresponding to an increase in the volume of the auxiliary air chamber member 10, and thus reduction in size and weight can be achieved.

Further, in the present embodiment, it is possible to improve a ride comfort by reducing an unsprung weight and to achieve reduction in fuel consumption. Furthermore, in the present embodiment, is possible to improve an assembling performance to the vehicle wheel 1 by reducing the length in the circumferential direction of the auxiliary air chamber member 10.

### REFERENCE SIGNS LIST

1: vehicle wheel
10: auxiliary air chamber member (Helmholtz resonator)
11c: well portion
11d: outer peripheral surface
14a, 14b: edge portion
25a: upper surface portion
25b: lower surface portion
33: connecting portion
33a, 33b: upper connecting portion
34a, 34b: lower connecting portion
36: non-connecting portion
38: curved surface
SC: auxiliary air chamber
G: cross-sectional center of gravity
B: bead

1. A vehicle wheel with an auxiliary air chamber member as a Helmholtz resonator mounted on an outer peripheral surface of a well portion, wherein
the auxiliary air chamber member comprises:
a lower surface portion disposed on the outer peripheral surface side of the well portion;
an upper surface portion disposed radially outward of the lower surface portion;
an auxiliary air chamber formed between the upper surface portion and the lower surface portion;
a first edge portion and a second edge portion respectively connecting the lower surface portion and the upper surface portion on both sides in a width direction and engaged with the well portion; and
a plurality of connecting portions recessed into the auxiliary air chamber from at least one of the upper surface portion and the lower surface portion to partially connect the upper surface portion and the lower surface portion, and wherein
a non-connecting portion of the lower surface portion excluding the plurality of connecting portions is a curved surface corresponding to a shape of the outer peripheral surface of the well portion,
the plurality of connecting portions are arranged separated at equal intervals in a wheel circumferential direction and have a first connecting portion on one side and a second connecting portion on an other side that are arranged in parallel in a wheel width direction,
the first connecting portion and the second connecting portion are respectively arranged offset in the wheel width direction with reference to a cross-sectional center of gravity G, and
a separation distance from the cross-sectional center of gravity G to the first connecting portion disposed offset in the wheel width direction and a separation distance from the cross-sectional center of gravity G to the second connecting portion disposed offset in the wheel width direction are different from each other.

2. (canceled)

3. The vehicle wheel according to claim 1, wherein the auxiliary air chamber member does not comprise a bead connecting the first connecting portion and the second connecting portion.
